(19) United States
(12) Patent Application Publication
(10) Pub. No.: US 2013/0203363 A1
(43) Pub. Date: Aug. 8, 2013

(54) Personal Communications Device with Reduced Adverse Effects on Living Systems

(71) Applicants: Asher Gratt, London (GB); Itay Sherman, Hod Hasharon (IL)

(72) Inventors: Asher Gratt, London (GB); Itay Sherman, Hod Hasharon (IL)

(73) Assignee: MAGDI LIMITED, London (GB)

(21) Appl. No.: 13/807,840

(22) PCT Filed: Jul. 29, 2011
(86) PCT No.: PCT/GB2011/051441

§ 371 Date: Apr. 1, 2013

(30) Foreign Application Priority Data
Jul. 30, 2010 (GB) 1012865.0

(51) Int. Cl. H04B 1/38

(52) U.S. Cl. CPC H04B 1/38
USPC 455/73

(57) ABSTRACT

Personal communications devices and associated methods are described which are arranged to reduce a bio-effective impact on a user due to the associated radio frequency communication signals. One such device (300) comprises means (360) for generating a radio frequency communication signal and means (212) arranged to generate a low frequency modulated RF confusion field during communications using the radio frequency communication signal.

### FIELD

The present invention is in the field of communications and is concerned in particular, but not exclusively, with reducing adverse effects on a living system due to harmful radiation emanating from wireless personal communications devices and the like.

### BACKGROUND

It has been widely accepted that the radiation emanating especially from wireless communication devices has the potential to be harmful to people who use the devices. Wireless communication devices include mobile phones, wireless PDAs, Internet connected devices, personal area networking (e.g. Bluetooth) devices, WiMax devices, GPS navigators, and generally any other product that performs wireless communications. For convenience only, the term ‘personal communications device’ (PCD) will be used herein as a generic descriptor of all kinds of wireless communication devices and/or equipment that a person may use or be exposed to (for example, including wireless network devices that may be shared and not for personal use as such).

Scientists, health organisations, government agencies, wireless communications network operators and PCD manufacturers have over time collaborated to generate various standards, which prescribe the maximum levels of radiation that PCDs are permitted to radiate to perform wireless communications operations.

However, there are known trade-offs between radiation power level and PCD performance, where a higher power typically increases performance, for example, in terms of maximum operational distance between a transceiver (e.g. a radio tower or satellite) and a PCD, and signal quality (e.g. signal to noise ratio, error rate, drop outs), etc.

PCD manufacturers have the challenge of designing products that comply with standards while maintaining an acceptable level of performance, and there is a large body of research and associated publications and patent applications concerned with this field. For example: EP1229664 describes a mobile device that is able to detect the proximity of human tissue to the device and decrease the number of timeslots used (in a time division multiple access “TDMA” system), or reduce signal power, when the device is moved closer to human tissue; EP1487124 describes a mobile device that has two communications modes—a first mode (i.e. a high power mode) when the device is installed in a cradle unsuitable for direct human user interaction, and a second mode (i.e. a low power mode) when the device is in use by, and proximal to, a user; and US2003064761 describes a mobile device that is adapted to reduce specific absorption rate (SAR) values by detecting when the device is close to a human user and reducing the number of timeslots used for communications, thereby reducing SAR values.

Another approach for reducing harmful PCD effects is described in U.S. Pat. No. 6,957,051, which provides a way of shielding an operator from electromagnetic fields using a plurality of active shields placed between the operator's earpiece and the antenna, in order to cancel the effects of the electromagnetic fields in the vicinity of an operator's head. The active shields operate by taking a small portion of the antenna signal and using adjustment circuits to shift the phase and amplitude of the signal to produce signal that is opposite to that produced by the antenna, which can be used to cancel the antenna signal in the required vicinity.

Many other documents exist that describe similar problems and solutions.

There is another body of research demonstrating that it is not only radiation power level that can be harmful to people. For example, U.S. Pat. No. 6,263,878 identifies problems caused by electromagnetic fields, particularly those fields which are alternating or pulsating or being modulated at frequencies below 500 Hz: which are referred to therein as ‘extremely low frequency’ (ELF) fields. The patent goes on to suggest, however, that precautions should be taken for frequencies of up to 100 kHz, in view of a belief that even at such relatively higher frequencies the periodic nature of the fields that are generated can be harmful to people. According to the experimental results described in U.S. Pat. No. 6,263,878, ELF frequencies in particular have been found to induce undesirable changes in living cells (that is, they are ‘bio-effective’), whereas frequencies exceeding the ELF range have a significantly lower influence on cell change. U.S. Pat. No. 6,263,878 is particularly concerned with electrical power distribution frequencies at 60 Hz (U.S.) and 50 Hz (U.K. and continental countries). The patent proposes that the harmful effects can be reduced by modifying one or more characteristic signal parameters, including at least one of: the ambient time varying electric, magnetic or electromagnetic field to which a living system is exposed. According to the patent, the modification can be achieved by transposing a so-called ‘confusion field’ (for example due to a noise signal), having a time-varying amplitude, frequency (period), phase, wave form or direction-in-space, which suppresses the effect of the ELF field on living cells. U.S. Pat. No. 5,544,665 identifies similar concerns with mobile devices, and proposes a solution whereby a multi-turn coil may be incorporated into the device, concealed along the periphery of the device. The coil is driven by an ELF signal and is arranged to induce a confusion field to be transposed onto the transmission field, in order to suppress the ELF emitted by the device. The additional coil and associated circuitry are powered directly by a battery of the device, and the inclusion of the coil and circuitry is designed not to interfere with the operation of the device and to be operationally transparent to users.

### SUMMARY

Aspects and embodiments of the present invention relate to suppressing an adverse effect on a living system due to the presence of relatively low frequency modulation of relatively high frequency communication channels, as described hereinafter and/or as claimed in the claims appended hereto.

### BRIEF DESCRIPTION OF THE DRAWINGS

Various features and advantages of the invention will become apparent from the following description of embodiments of the invention, given by way of example only, which is made with reference to the accompanying drawings, of which:

FIG. 1a is a diagram that illustrates a periodic slot assignment in each of a sequence of frames of a communication channel according to the prior art;

FIG. 1b is a diagram that illustrates a periodic slot assignment in every other frames of a communication channel according to the prior art;

FIG. 1c is a diagram that illustrates a sequence of slots in frames of a communication channel according to the prior art;

FIG. 2 is a block diagram of a mobile station according to an embodiment of the present invention that uses WLAN radio to create a confusion field;

FIG. 3 is a flow chart of the operation of the CFCF (confusion field control function) that controls the WLAN transceiver that creates the confusion field;

FIG. 4 is a block diagram of a mobile station according to an embodiment of the present invention that uses NFC radio to create a confusion field; and

FIGS. 5a-5f are time domain graphs, respectively illustrating a GSM waveform, an envelope of the respective GSM waveform, a confusion field waveform, an envelope of the confusion field waveform, a combined waveform, and an envelope of the combined waveform.

### DETAILED DESCRIPTION

Various embodiments of the present invention will now be described in more detail with reference to the accompanying drawings. It will be appreciated that the invention is not limited in its application to the details of method(s) and the arrangement of components as set forth in the following description or illustrated in the drawings. It will be apparent to a person skilled in the art that additional embodiments of the present invention not detailed in the description are possible and will fall within the scope of the present claims. Accordingly, the following description should not be interpreted as limiting in any way, and the scope of protection is defined solely by the claims appended hereto.

Outwardly, it may not be evident that PCDs could generate any kind of harmful ELF. For example, GSM & 3G PCDs operate at main carrier RF frequency bands exceeding 300 MHz. However, in arriving at embodiments of the present invention, it has been appreciated that even PCDs communicating at relatively high frequencies may be harmful to people who use or come into contact with the PCDs, for example, due to the low frequency modulation of their high frequency RF carrier signal. For the present purposes, the term ‘low frequency modulated RF signal’ (LFMRF) will be applied to RF signals that are modulated with sinus or pulses of frequency lower then 100 Khz.

Embodiments of the present invention are generally adapted to employ a new source of LFMRF, which is generated with the intention of reducing or countering the bio-effective impact of PCDs. In certain embodiments of the invention, the LFMRF is conveniently generated using existing PCD circuitry and radio technologies, for example in the form of near field communications (NFC), wireless local area network (WLAN) or personal area network (PAN) circuitry. Such circuitry tends to be substantially separate from the circuitry that is used, for example, for cellular communications. However, before describing embodiments of the invention in greater detail, a further analysis of the nature of harmful ELF in the form of LFMRF in existing PCDs will be provided.

For example, it has been appreciated that TDM-based systems, such as GSM, typically allocate a voice communications channel to a particular slot (or slots) in neighbouring timeframes, as a result of which LFMRF can arise. In particular, LFMRF arises as a result of the periodic ‘pulsing’ of signalling, control or traffic bursts allocated to associated timeslots in consecutive timeframes. In contrast, code division multiple access (CDMA) technologies, such as are employed in some 3G schemes and the like (and, perhaps, future technologies such as 4G, LTE and beyond), typically generate a constant power level of communications signal throughout a call or session, relying on spread spectrum and other coding techniques to enable a differentiation between signals from concurrently operating PCDs. However, while the communication channels outwardly would not appear to cause LFMRF, it has been appreciated that certain signalling and control signals associated with the communications do. In particular, in 3G for example, maintaining a constant transmission power level is important, and, to achieve this, periodic power control pulses are generated, which are a source of LFMRF. To exacerbate this issue in 3G and the like, the power control pulses are generated at a higher power than the constant communications signals, to cause relatively high power periodic control pulses.

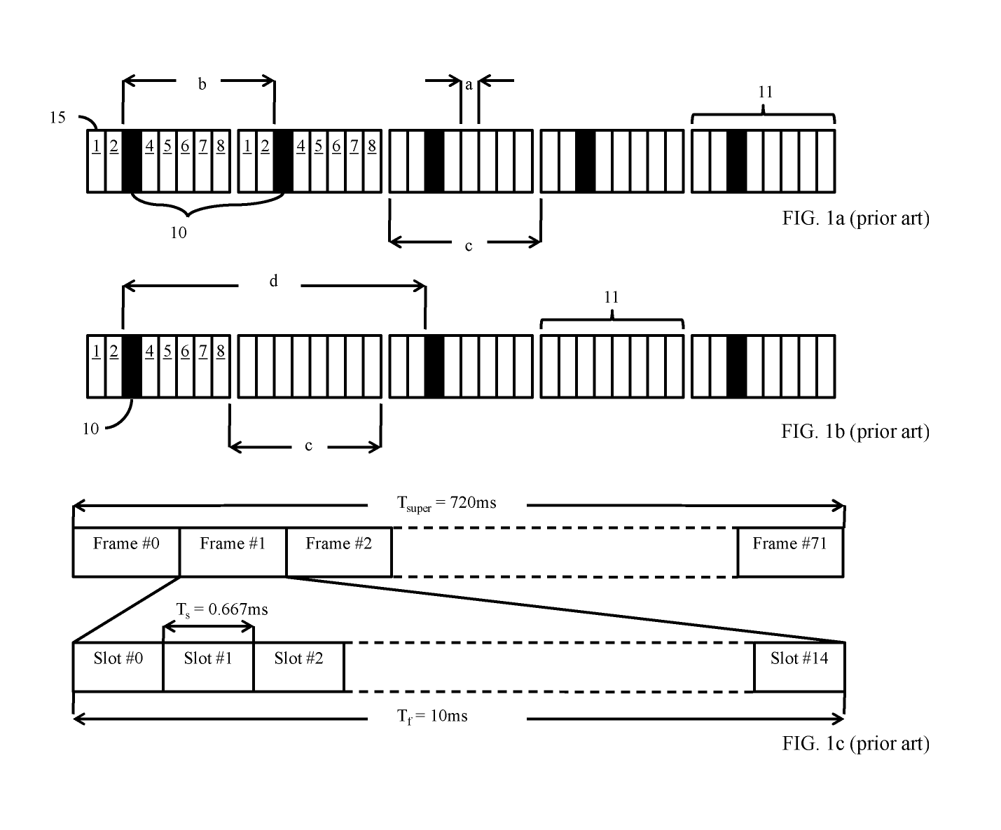

All references to GSM herein relate to ETSI TS 144 018 Digital cellular telecommunications system (Phase 2+); Mobile radio interface layer 3 specification; Radio Resource Control (RRC) protocol (3GPP TS 44.018 version 9.4.0 Release 9) unless otherwise specified. Taking the GSM mobile communications standard as an example, with reference to FIG. 1a, a voice communications channel transmits traffic bursts 10 in timeslots 15 that are a=3/52000s (that is, about 577 μs) long. The bursts 10 may be assigned to timeslots 15 on a one-per-frame 11 basis, where each frame 11 accommodates eight timeslots. In this example, each burst occurs in timeslot 3 of each consecutive frame 11, to produce a pattern of traffic bursts, which is periodic over consecutive timeframes. In effect, the period between bursts is fixed. Accordingly, if the channel is communicated by traffic bursts in one timeslot in each frame, the timeslots occur every b=4.615 ms, which is the same as the frame duration, c. This means that a burst of energy arises every 4.615 ms, which is equivalent to a burst frequency of 217 Hz. According to U.S. Pat. No. 6,263,878, this frequency constitutes an ELF, which is bio-effective. Even if, as illustrated in FIG. 1b, timeslots 10 arise in only every other timeframe, which is the case in half rate GSM, the field generated by the timeslot bursts is at a frequency of 108.5 Hz (that is, pulse spacing d=9.23 ms), which constitutes an ELF and is also bio-effective according to U.S. Pat. No. 6,263,878. It will be appreciated that the illustrations in FIGS. 1a and 1b are merely representative and are not intended to be accurate depictions of GSM.

Taking 3G as another example, with reference to FIG. 1c, it can be seen that communications are performed according to a hierarchical format in which consecutive 720 ms Superframes each comprise 72 Frames, each being 10 ms in duration. Each frame comprises 15 slots, which are 0.667 ms in duration, and each slot includes a power control signal, such that power control signals pulse every 0.667 ms, which corresponds to a frequency of 1.5 kHz. This frequency falls well within the definition of potentially harmful LFMRF. In addition, although not so pronounced as the power control pulses, it has been appreciated also that inter-frame pulsing can occur at 100 Hz in 3G systems, which, again, is a LFMRF signal.

While the following exemplary embodiments relate particularly to GSM, the principles can be applied equally to any technology that is based on GSM, or on any other wireless communication protocol that uses a TDM/TDMA approach in an air interface; such as 2G mobile phone technologies generally (including GSM and others), DECT, Bluetooth, and the like. In addition, while the principles of embodiments of the invention can be applied to known systems (such as GSM) in which there is typically a fixed base station transceiver (or equivalent), which can communicate with one or more PCDs over an air interface, the same principles can be applied to systems in which the air interface supports direct communications between two or more PCDs, satellites and PCDs and/or other mobile base station transceivers. Indeed, the principles of embodiments of the invention may be applied to any system supporting a TDM/TDMA air interface, and references herein to GSM-specific principles, devices and systems should, as the context permits, be treated generically, insofar as equivalent principles, devices and systems are employed by other technologies and communications protocols.

It will also be appreciated that, in addition to CDMA, the principles taught herein can be applied to other channel access techniques, such as (but not limited to) frequency division multiple access (FDMA), space division multiple access (SDMA), polarisation division multiple access (PDMA), frequency division duplex (FDD), time division duplex (TDD) and pulse address multiple access (PAMA), to the extent that they generate LFMRF bio-effective fields. As has already been explained, this is the case for 3G and would be the case, for example, when any one or more of these other channel access techniques is/are combined with TDMA. Indeed, GSM employs FDMA to support the transmission of multiple communications channels within each timeslot, so it employs a ‘combined’ technique. Thus, embodiments of the present invention are in no way limited to the use of TDM or TDMA alone, and certainly encompass CDMA in the guise of 3G at least. Indeed, embodiments of the present invention may be applied to any known or future communications system that generates LFMRF bio-effective fields by any means whatsoever; including (without limitation) Long Term Evolution (LTE), LTA-A and WiMAX technologies.

According to the prior work described above, a confusion field typically comprises a magnetic or electric field and the modulation thereof typically comprises time variation of at least one of amplitude, phase or frequency. It will be appreciated that, when dealing with bursts, the concepts of phase and frequency may more accurately be considered as cycle period and duty cycle. Nevertheless, the nature of a LFMRF suitable for counteracting a harmful bio-effective impact may be the same for burst-induced and non-burst-induced harmful effects.

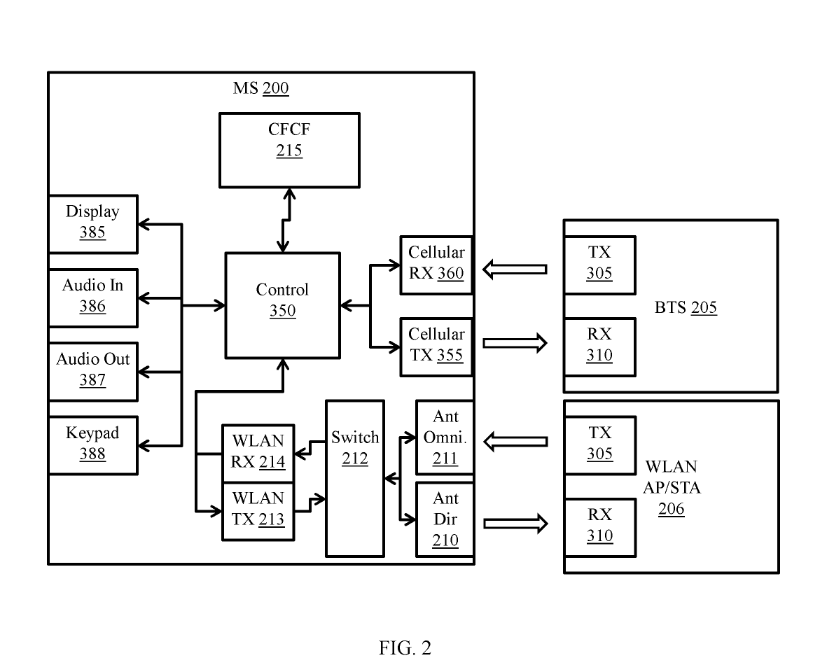

An embodiment of the present invention may be implemented using a relatively standard GSM mobile communications arrangement of the kind illustrated in FIG. 2, in which a PCD in the form of a mobile station (MS) 200 can communicate via wireless cellular communications with a base transceiver station (BTS) 205, which includes a transmitter 305 and a receiver 310. In addition, or alternatively, the MS 200 can communicate via WLAN, with other WLAN stations (not shown) and/or a WLAN Access Point 206, which includes a transmitter 305 and a receiver 310. The WLAN communications of the MS 200 are performed by a WLAN transmitter 213 and a WLAN receiver 214 arrangement, which are connected via a switch 212 to a directional antenna 210 and an omni-directional antenna 211. The MS 200 also includes a confusion field control function (CFCF) 215. Normal GSM communications are performed by a standard cellular radio transceiver (that is, a transmitter 355 and receiver 360) arrangement, which according to the present embodiment can be operated independently of the WLAN subsystem (for example, so that cellular communications and WLAN communications can be performed at the same time). The MS 200 further includes a controller 350, which typically comprises an embedded control processor for controlling the overall operation of the MS 200, including the operation of the radio interfaces. The MS 200 also includes standard user interface elements, such as Audio In 386, Audio Out 387, a keypad (or touch-screen) 388 and a display 385.

In general terms, a WLAN transmission creates an electric field around a respective antenna area. The strength of this field typically depends on the transmitted power as well as the radiation pattern and gain of the antenna. According to embodiments of the invention, in order to create an effective electrical confusion field, the field strength sensed at the user head while using the device should be similar to the strength of the electric field created by the cellular signal. In embodiments in which WLAN functionality is employed to generate a confusion field, the temporal characteristics of a respective WLAN transmission should adhere to specific patterns, for example, as recommended in the different experimental prior works that have been cited. Since in most standard MS the output power of the WLAN transmitter is considerably lower than the peak power of a cellular transmitter (for example, a typical WLAN power level is 17 dbm, whereas it may be 30 dbm for cellular GSM communications) some embodiments of the invention employ an antenna arrangement, used for the transmission of the confusion field, which is adapted to focus (or concentrate) radiation, and thereby provide an increased gain, towards the head of the user. In this way, despite the significant power level differentials between typical GSM communications and WLAN, the relatively lower power but focused/concentrated confusion field that results is capable of compensating for the harmful effects of the relatively higher power GSM communications. Such an antenna design may comprise a directional antenna that has high gain in a specific direction, in particular towards the head of the user, at the expense of lower gain in the other directions. This type of directional antenna would typically not be suitable for standard WLAN transmission, where relatively omni-directional antennas are more usually required. In order to resolve this conflict in requirements, embodiments of the present invention include two separate antennas: the directional antenna 210 and the omni-directional antenna 211. The two antennae are connected to the WLAN transmitter 213 via the switch 212. The switch toggles between normal transmit and receive states, in which the WLAN transmitter 213 and receiver 214 are connected to the omni-directional antenna 211, and a dedicated confusion field state, in which the WLAN transmitter 213 is connected to the directional antenna 210.

In alternative embodiments, for example in which the addition of an antenna is deemed cost-prohibitive, only a single antenna may be provided for WLAN signals. Then, for example, WLAN signal power levels may be varied as required, respectively, for WLAN transmission and confusion field generation. In such cases, for example, the signal power level for confusion field generation may be higher than for normal WLAN transmission. Accordingly, the WLAN signal may then not need to be focused or manipulated in any particular way. In still more embodiments, the WLAN signal level power may not be significantly increased for confusion field generation. In such cases, a reduction in the harmful effects of ELF may still be significant. On the basis of the teaching herein, the skilled person would of course be able to vary signal power and antenna parameters to provide a desired reduction in harmful ELF. In still more embodiments, the present inventors expect that a single dynamic WLAN antenna may be employed, in which the transmission characteristics thereof can be manipulated to operate in two or more different modes, to perform at least normal WLAN transmissions and confusion field transmissions respectively as required.

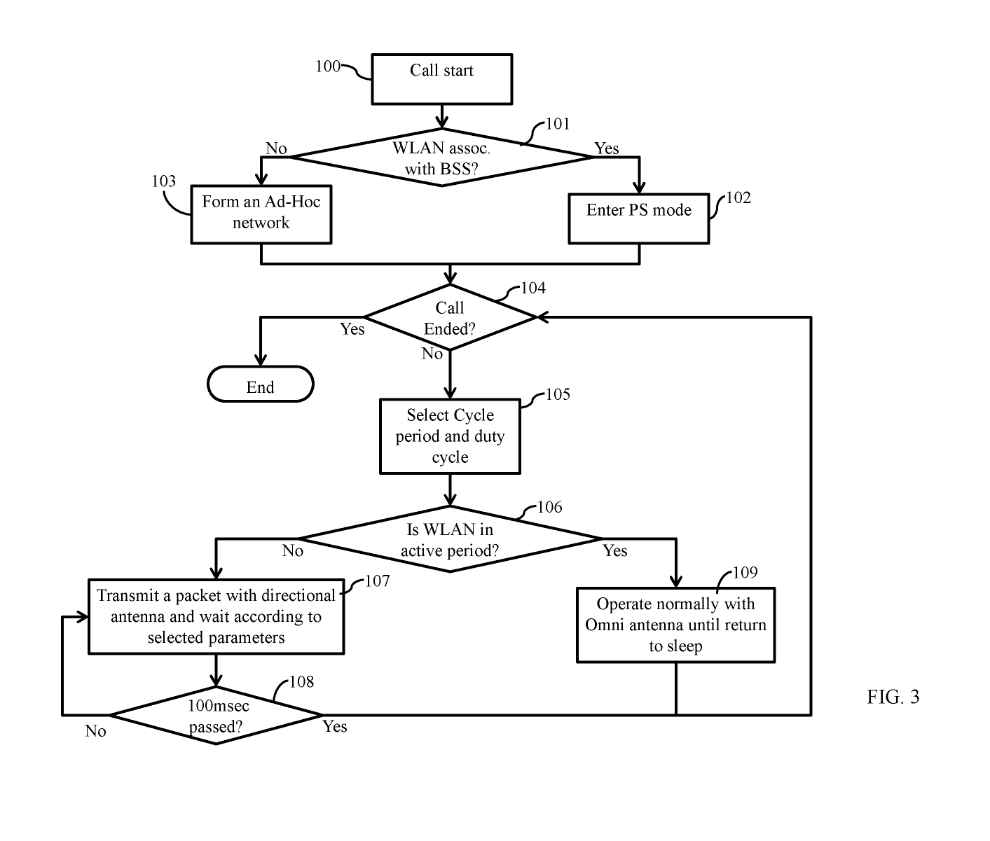

The CFCF 215 can be implemented in a dedicated processor, as firmware on the main mobile controller 350 or as a software application. The CFCF 215 controls the operation of the WLAN transmitter 213, when a confusion field is required, and the state of the switch, to ensure that the confusion field is emitted via the directional antenna 210 towards the head of the user. The CFCF 215 is arranged to create the time varying LFMRF modulation of the WLAN RF carrier signal when the confusion field is required. The flow diagram in FIG. 3 illustrates one possible flow of operation of the CFCF 215.

The CFCF 215 begins operation on GSM call initiation 100. The state of WLAN activity is tested 101. If the MS 200 is found to be active on a specific GSM basic service set identifier (BSSID), then the WLAN transmitter 213 and receiver 214 (collectively, the “WLAN transceiver”) are instructed to operate in a Power Save mode 102. If the MS 200 is currently not active on any basic service set (BSS) the WLAN transceiver is instructed to form an Ad-Hoc network with dummy BSSID 103. The CFCF 215 then generates two parameters: cycle time and duty cycle 104. These two parameters are created in a specific range. By way of example, cycle time may be chosen from the range of 100-300 hz and the duty cycle may be chosen in the range of 30-70%. According to the present embodiment, the selection of the parameters is based on a known pseudo random function (not shown), which forms a part of the CFCF 215. The implementation of this pseudo random function depends on the specific system and, for example, can be based on a linear feedback shift register design, or use another known technique such as a linear congruential generator. If the WLAN is not found to be associated to a BSS, or if it is associated to a BSS but it is currently in a sleep period 105, then the CFCF 215 controls the WLAN transmitter 213 to transmit a burst of WLAN packets through the directional antenna, comprising a signal of length (cycle period*duty cycle), and then wait idle for the remainder of the cycle period 106. According to the present embodiment, the process is repeated until 100 msec has elapsed 107, at which point the random selection of parameters is executed again 104. If the WLAN is found to be associated to a BSS and it is in its active period then control is passed to a standard WLAN driver (not shown), which transmits and receives WLAN signals via the standard antenna 108. The process is terminated when the call is disconnected 109.

It is emphasized that the specific parameters and flow of the CFCF function 215 could be altered and modified. The presented implementation is provided by way of example only. For example, any CFCF implementation that creates a modulation signal in which periodicity and/or duty cycle and/or amplitude are changed within a reasonable range, and for example with a change in period in the range of 0.1-1 second, would provide the required functionality. The content of the transmitted WLAN packets of the confusion field is immaterial and can be a random or any other content.

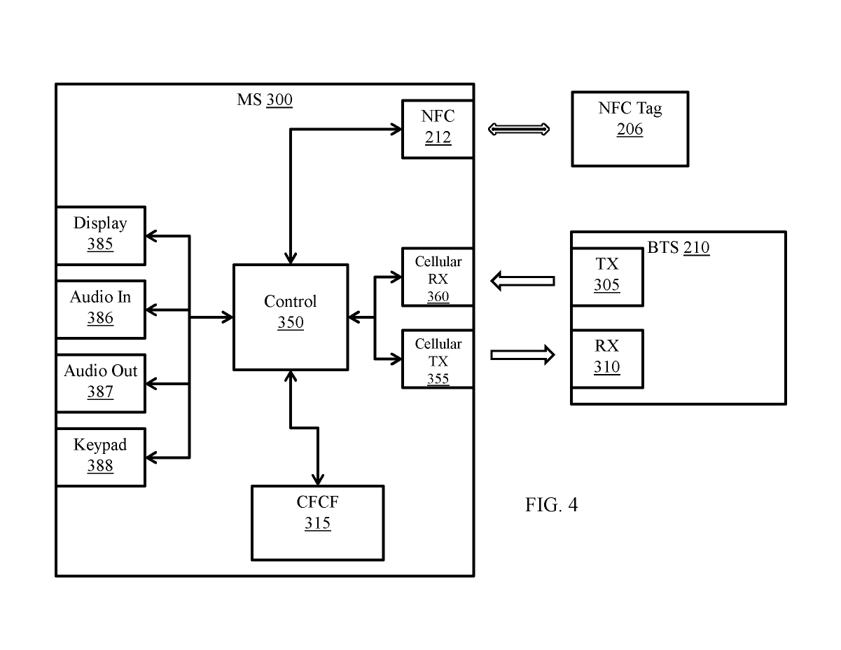

An alternative embodiment of the present invention may be implemented using a standard GSM mobile communications arrangement of the kind illustrated in FIG. 4, in which a mobile station (MS) 300 can communicate via wireless cellular communications with a BTS 205 and, via NFC, with other NFC-enabled mobile stations or an NFC enabled tag 206. For reasons of brevity, the components of the MS 300 that have the same reference number as the components in the MS 200 in FIG. 2 have generally (but not necessarily exactly) the same function and operating characteristics, and will not be described again. The significant difference in the MS 300 is the omission of a WLAN subsystem and, instead, the inclusion of an NFC reader 212, which can be controlled to generate a confusion field by a CFCF 315, as will be described. Of course, the MS 300 could, in addition, include a standard WLAN sub-system.

NFC devices operate by magnetic induction. For example, an NFC reader emits a magnetic field that is detected by an NFC tag 206. In some systems, for example, the NFC tag 206 is passive (that is, it has no internal power supply) and the magnetic field from the reader energises tag circuitry, which, in turn, generates a magnetic ‘response’ field, which is detected by the reader. In other systems, a tag or other NFC-enabled device may incorporate an internal power supply. In any event, the MS 300 and NFC device(s) communicate by modulating a carrier of the magnetic energy. The carrier frequency may be 13.56 MHz. An exemplary NFC reader is designed to emit a magnetic field that is in the range of 1.5 A/m-7.5 A/m. For free space, this translates to 2-10 uT. Prior art experimental work performed on confusion fields showed that a magnetic field with strength of 4-6 uT is capable of masking the negative effects of an electric ELF field. Accordingly, it has been appreciated that the magnetic field induced by an NFC reader is capable of being used to create a confusion field, suitable for suppressing harmful bio-effective effects. In order to provide an effective confusion field, the magnetic carrier frequency is, for example, modulated with a random pattern. The CFCF 315 in the MS 300 performs this function simply by toggling on and off the activity of the NFC reader 212 in a random fashion (i.e. with a randomly variable delay between on and off states), and/or by varying one or more other parameters, such as amplitude/power, frequency, delay between bursts, etc. In this manner, the magnetic field that is induced performs as a confusion field according to embodiments of the present invention. In other respects, the CFCF 315 is similar in function to the CFCF 215 in FIG. 2.

Many mobile handsets nowadays include WLAN and/or NFC capabilities. For such handsets, the WLAN and NFC embodiments that have been described herein would typically require no (or minimal) hardware redesign. The significant addition in each implementation is the CFCF block (215 and 315), or equivalent. While this block may be implemented as additional hardware, as has been alluded to it may instead conveniently be implemented in firmware or even as a ‘downloaded’ software application, either of which may be installed onto a standard handset in a known way. In WLAN embodiments, as described, in addition, may be the switch 212 or equivalent. Again, such a switch function can be provided as an additional hardware component or as a firmware and/or software program installation.

While many handsets include embedded WLAN and/or NFC capabilities, embodiments of the invention can also be embodied in certain handsets that do not have such intrinsic capabilities. For example, certain handsets provide a card slot, for example a secure digital (SD) card slot, that can receive a NFC-enabled SD-format card of known kind A known NFC SD card is sold by Wireless Dynamics as the SDiD™ 1020 RFID SD Card. Such a card can be plugged into any handset with an SD card slot to imbue the handset with NFC capability, such that the handset can then be arranged as described to perform according to embodiments of the present invention. Of course, formats of card other than SD may be employed, depending on which format of slot is provided by a particular handset, and, indeed, any other way of connecting an NFC receiver to a handset may be employed (e.g. via a mini-USB interface). Of course, other kinds of signalling capability (e.g. Bluetooth, WiFi) may instead (or in addition) be added to a handset to perform according to embodiments of the present invention.

Additional embodiments of the present invention may use other types of radio technologies that emit electric or magnetic fields with high frequency carrier (e.g. >1 Mhz) and could be integrated into mobile stations. The confusion field may be derived by modulating the carrier of these radio technologies using pulses with varying cycle period and duty cycle, and/or amplitude or sinusoidal patterns with varying frequency amplitude or phase.

These additional radio technologies may include but are not limited to, citizen band (CB) radio or FRS radio or other similar WalkiTalki radios operating in different frequency bands, cordless handset radios operating at 900 Mhz or other frequencies. Other NFC technologies using different ISM (industrial, scientific and medical) frequencies such as 6.78 Mhz or other WLAN operating in other bands (e.g 5 Ghz) or other short range technologies (e.g. BT, Zigbee), as well as Ultra wide band technologies in 6 Ghz or even the 60 Ghz range.

For all these additional technologies the emitted field would typically need to fulfil basic criteria in order to qualify for creation of a confusion field, including:
1. an electric field in the area of the head that is similar to the emitted electrical fields from cellular radio or magnetic fields, for example >2 uT; and
2. an RF carrier frequency modulated as described above.

It is emphasized that the specific parameters and flow of the CFCF function could be altered and modified. The presented implementation is provided as an example only. Any CFCF implementation that creates a modulation signal in which periodicity and/or duty cycle and/or amplitude are changed within a reasonable range and, for example, with a change period in the range of 0.1-1 second, would provide the required functionality. As has already been explained, the content of the transmitted packets of the confusion filed is immaterial and can be a random or any other meaningless and/or dummy content.

In considering further the nature of a confusion field, it will be appreciated that embodiments of the invention do not attempt to reduce the overall field intensity due to an emitted communications signal field. This is in contrast with the intention of certain prior art documents, such as U.S. Pat. No. 6,957,051 (described above), which in effect attempts to ‘cancel out’ the communications field in the proximity of an operator's head, by phase shifting and superimposing an inverse signal portion on the communications signal. Accordingly, any definition of ‘confusion field’ herein would exclude the principle of manipulating a portion of the normal communications signal and, for example, using active shields to cancel out the entire communications signal in a certain region.

Indeed, in the aggregate, certain embodiments of the invention will tend to increase field intensity in the region of an operator's head, by virtue of the addition of a confusion field to the normal field. The principle of increasing overall field intensity, by including a confusion field in order to reduce harmful effects of ELF, is, of course, counterintuitive when considering at least the prior art that endeavours to shield or cancel the field near to a human operator's head. Put another way, embodiments of the present invention aim to reduce the harmful effects of ELF by generating an additional LFMRF confusion field that effectively combines with the normal field (as far as an operator's cell tissues are concerned) to reduce the harmful effects of ELF caused by a normal communications signal. Another way of explaining the effect is that a LFMRF confusion field augments a normal communications signal (without interfering with the communications channel), by introducing additional field elements/components, in a way that masks or obscures the presence of any periodic element of the un-augmented, normal field.

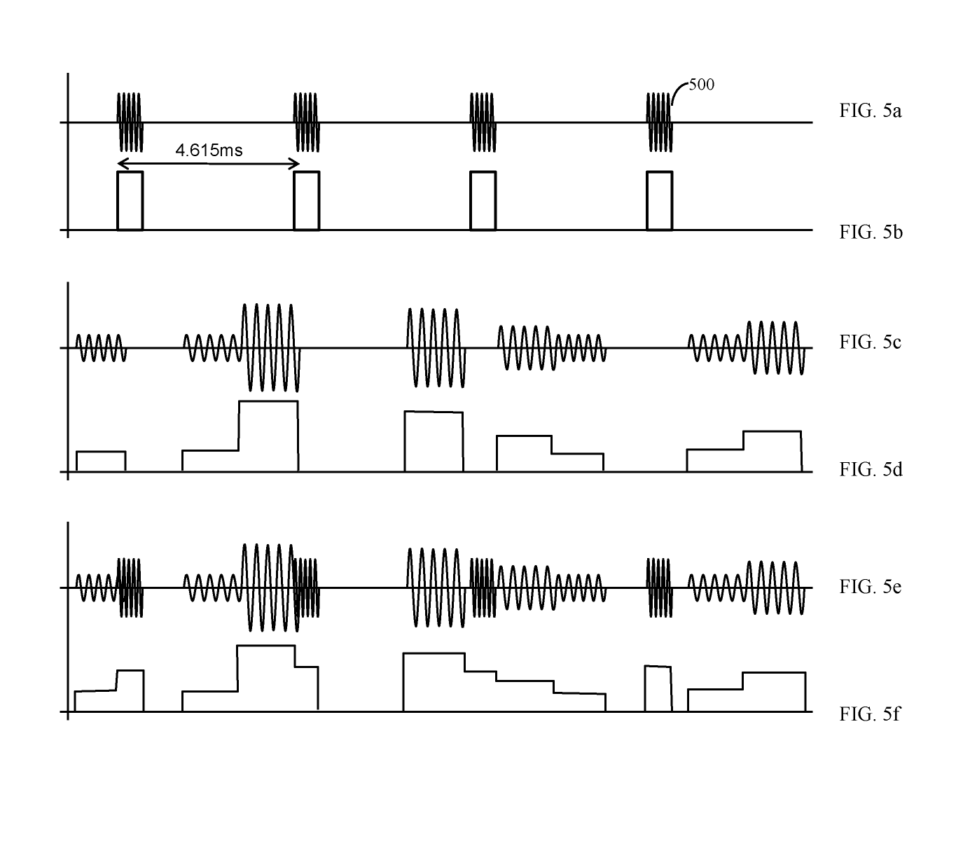

The effect of applying a confusion signal to a normal communications signal is further illustrated in the time domain graphs of FIGS. 5a-5f. In each graph, the x-axis represents time t and the y-axis represents amplitude A (though neither axis is intended to be to scale). The waveform in FIG. 5a is illustrative of standard GSM signal, for example having a carrier frequency of 900 Mhz, in which communications bursts 500 occur every 4.615 ms. The waveform in FIG. 5b is illustrative of what human cells would detect (or experience) if exposed to the waveform of FIG. 5a. In effect, the cells having a non linear response detect the envelope of the waveform, the envelope having clear periodic ELF characteristics: i.e. a signal pulsing at 217 Hz.

The waveform in FIG. 5c illustrates a randomly varying LFMRF confusion signal waveform, of the kind that can be generated, for example, by a WiFi or NFC circuit as described herein. In this example, the carrier frequency of the waveform is 13.56 MHz (i.e. a standard NFC carrier frequency). The waveform in FIG. 5d is illustrative of what human cells would detect (or experience) if exposed to the waveform of FIG. 5c. Again, the waveform is the envelope of the original signal, but this time having a randomly varying envelope, with no apparent periodic ELF characteristics.

The waveform in FIG. 5e illustrates a combination or superposition of the waveforms of FIGS. 5a and 5c. As can be seen, although the waveform still includes the 900 MHz GSM waveform (and GSM communications can still be performed), in addition to the randomly-varying 13.56 MHz NFC waveform, the combined waveform adopts a quasi-random form. FIG. 5f, is illustrative of what human cells would detect (or experience) if exposed to the waveform of FIG. 5e. As can be seen, the combined signal also has a quasi-random envelope, with significantly reduced ELF characteristics. According to embodiments of the present invention, such a waveform would have a far lesser adverse effect on human cells than the waveform in FIG. 5b. In effect, the LFMRF signal augments the normal communication signal so that the envelope of the combined signal is no longer periodic (i.e. it is substantially aperiodic, or at least has significantly reduced apparent periodicity inasmuch as periodic ELF components are rendered less distinct). In other words, the energy spectrum of this envelope signal is more evenly spread (or distributed) across frequencies and does not have the distinct low frequency, ELF, peaks of the normal communication signal envelope.

The above embodiments are to be understood as illustrative examples of the invention. Further embodiments of the invention are envisaged. It is to be understood that any feature described in relation to any one embodiment may be used alone, or, if the context permits, in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A personal communications device, comprising:
a signal device for generating a radio frequency communication signal; and
a confusion device arranged to generate a separate low frequency modulated RF confusion field during communications using the radio frequency communication signal to produce a superposition of the communication signal and confusion field,
wherein the envelope of the superposition is aperiodic, thereby reducing a bio-effective impact on a user due to the radio frequency communication signal.

2. A personal communications device according to claim 1, wherein the confusion field is arranged to have at least one of a time-varying amplitude, frequency (period), phase, wave form and/or direction-in-space characteristic.

3. A personal communications device according to claim 2, wherein the time-varying characteristic is arranged to vary in a random or at least a quasi-random manner.

4. A personal communications device according to claim 1, wherein the confusion field comprises a relatively high frequency carrier modulated by a relatively low frequency signal, having a frequency, duty cycle, phase and/or amplitude that is modified periodically.

5. A personal communications device according to claim 1, wherein the confusion device arranged to generate the confusion field comprises a WLAN transmitter.

6. A personal communications device according to claim 5, wherein the confusion device arranged to generate the confusion field comprises first and second antennas, wherein the first antenna is driven during WLAN communications and the second antenna is driven during confusion field generation.

7. A personal communications device according to claim 6, further comprising a switch for switching the WLAN transmitter from the first antenna to the second antenna during confusion field generation.

8. A personal communications device according to claim 6, wherein the second antenna is a directional antenna, which is arranged to concentrate confusion field energy emitted therefrom towards the head of a user.

9. A personal communications device according to claim 1, which is arranged to produce a confusion field density, which is exposed to a head of the user, and which is similar to or greater than the electric field density, which is exposed to the head of the user during communications performed using the radio frequency communications signal.

10. A personal communications device according to claim 1, wherein the confusion device arranged to generate the confusion field comprises a NFC circuit.

11. A personal communications device according to claim 10, wherein the confusion field comprises a magnetic field with a density higher than 2 uT.

12. A personal communications device according to claim 1, wherein the low frequency modulated RF confusion field augments the radio frequency communication signal to introduce additional field elements/components that mask and/or obscure the presence of low frequency periodic elements of the radio frequency communication signal.

13. A personal communications device according to claim 1, wherein the low frequency modulated RF confusion field augments the normal communication signal so that an envelope of the combined signal has reduced distinct periodic ELF components, compared to an envelope of a normal communication signal.

14. A personal communications device according to claim 1, wherein the superposition of the low frequency modulated RF confusion field and the radio frequency communication signal results in an envelope signal in which frequencies are relatively more evenly distributed, and have relatively reduced distinct ELF frequency peaks, compared to the envelope of an un-superposition of the low frequency modulated RF confusion field and the radio frequency communication signal.

15. A personal communications device according to claim 1, wherein the signal device for generating a radio frequency communication signal and the confusion device arranged to generate a low frequency modulated RF confusion field have separate antennas for radiating the low frequency modulated RF confusion field and the radio frequency communication signal.

16. A personal communications device according to claim 1, further comprising a cellular radio handset.

17. A method of operating a personal communications device by generating first modulated radio frequencies for performing communications and simultaneously separately generating a low frequency modulated RF confusion field which is superposed on the first modulated radio frequencies, the envelope of the superposition being aperiodic, for reducing a bio-effective impact on a user due to the first modulated radio frequencies.

18. A software application operable to perform a method according to claim 17.

19. A software application operable to control a personal communications device according to claim 1.

20. A personal communications device, comprising means for generating a radio frequency communication signal and means arranged to generate a separate low frequency modulated RF confusion field during communications using the radio frequency communication signal to produce a superposition of the communication signal and confusion field, the envelope of the superposition being aperiodic, thereby reducing a bio-effective impact on a user due to the radio frequency communication signal.
